(19) United States
(12) Patent Application Publication
(10) Pub. No.: US 2009/0037829 A1
(43) Pub. Date: Feb. 5, 2009

(54) FRAMEWORK TO INTEGRATE WEB SERVICES WITH ON-PREMISE SOFTWARE

(75) Inventors: Ning Sun, Redmond, WA (US); Hai Zhuang, Issaquah, WA (US); Poul A. Constinsky, Seattle, WA (US); Marc V. Haddad, Redmond, WA (US); Srinivasan Parthasarathy, Redmond, WA (US); Ana M Arellano Lopez, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 12/057,373

(22) Filed: Mar. 28, 2008

Related U.S. Application Data
(60) Provisional application No. 60/953,453, filed on Aug. 1, 2007.

(51) Int. Cl. G06F 15/16; G06F 3/048

(52) U.S. Cl. 715/762; 709/201

(57) ABSTRACT

A service framework wherein a markup language based software development kit that maps an object model of a service SDK to a set of markup language schemas. On the basis of the markup language schemas the service may convert any service data object into a markup language string, and vice versa. All data exchange requests and responses are in the format of markup language strings such that web services perform data exchange with the service through standard internet technologies, for example JavaScript and SOAP. The UI of the service is abstracted to a markup language structure. The definition of interaction points of web services are also standardized, such that other services may customize the service user interface through a simple markup language string, passed via custom code. In this way, deployment and enlightening of web based services in the service may be controlled from the server or web service side.

### CROSS-REFERENCE TO RELATED APPLICATIONS

This application claims benefit to U.S. Provisional Patent Application No. 60/953,453 (attorney docket number 321668.01), filed on Aug. 1, 2007.

### BACKGROUND

In the “software as a service” model, a software developer creates and hosts a networked application for use by business customers over a network. Business customers pay for use of the service and not for the software itself. The business customers may then provide the service to customers of the business. Such software as a service may typically be comprised of Web Services implemented on the World Wide Web accessed by a client such as a World Wide Web browser.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present examples provide a service framework to integrate web services with on-premise software. One aspect of the service framework includes a markup based software development kit (SDK) that maps an object model of a software service to a markup based schema. Another aspect of the service framework includes a markup based abstraction of the user interface of the software service.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows an example of a computing device for implementing one or more embodiments of the invention.

FIG. 2 shows a data flow diagram illustrating how an example service is enlightened.

FIG. 3 shows a data flow diagram illustrating data exchange between an example World Wide Web based service and one or more software development kits.

FIG. 4 shows an example operation for an example service to mark an example order as shipped.

FIG. 5 illustrates an example serialization software development kit.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a service framework to integrate web services with on-premise software, the service framework described is provided as an example and not a limitation. As those skilled in the art will appreciate, the present examples are suitable for application in a variety of different types of service frameworks.

In one embodiment of the service framework, a markup language based software development kit that maps an object model of a service SDK to a set of markup language schemas. On the basis of the markup language schemas the service may convert any service data and/or service data object into a markup language string, and vice versa. As data exchange requests and responses are in the format of markup language strings, web services perform rich data exchange with the service through standard internet technologies, for example JavaScript and the Simple Object Access Protocol (SOAP).

In another embodiment, the user interface of the service is abstracted to a markup language structure. The definition of interaction points of web services are also standardized, such that other services may customize the service user interface through a simple markup language string, passed via custom code such as JavaScript. In this way, deployment and enlightening of web services in the service may be controlled from the server or web service side.

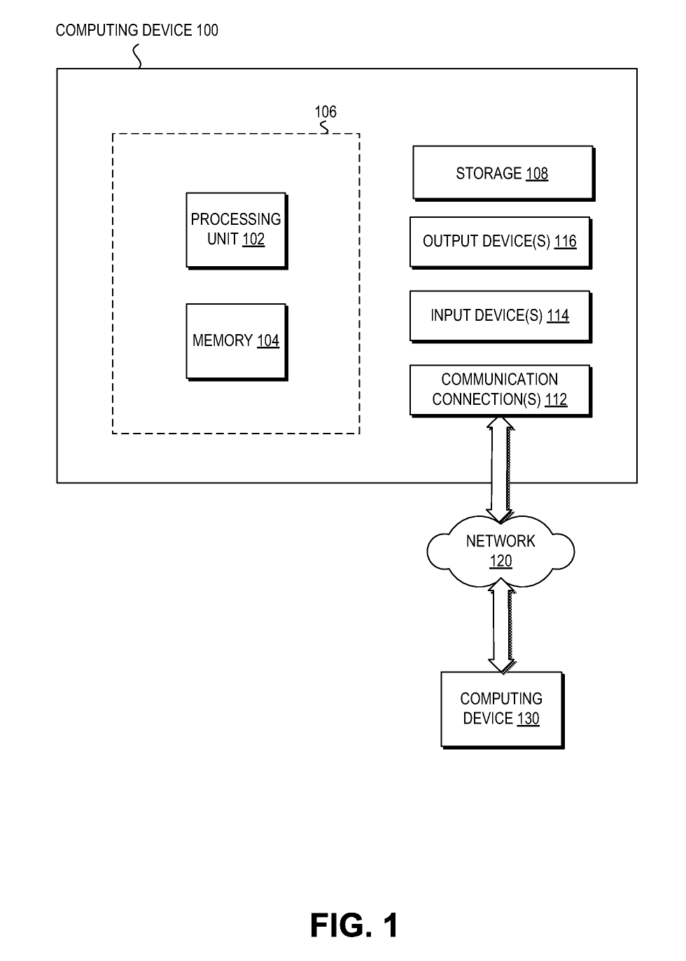

FIG. 1 and the following discussion are intended to provide a brief, general description of a suitable computing environment to implement embodiments of the invention. The operating environment of FIG. 1 is only one example of a suitable operating environment and is not intended to suggest any limitation as to the scope of use or functionality of the operating environment. Other well known computing devices, environments, and/or configurations that may be suitable for use with embodiments described herein include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments of the invention will be described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 1 shows an example of a computing device 100 for implementing one or more embodiments of the invention. In one configuration, computing device 100 includes at least one processing unit 102 and memory 104. Depending on the exact configuration and type of computing device, memory 104 may be volatile (such as RAM), non-volatile (such as ROM, flash memory, etc.) or some combination of the two. This configuration is illustrated in FIG. 1 by dashed line 106.

In other embodiments, device 100 may include additional features and/or functionality. For example, device 100 may also include additional storage (e.g., removable and/or non-removable) including, but not limited to, magnetic storage, optical storage, and the like. Such additional storage is illustrated in FIG. 1 by storage 108. In one embodiment, computer readable instructions to implement embodiments of the invention may be stored in storage 108. Storage 108 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions or other data. Memory 104 and storage 108 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also include communication connection(s) 112 that allow device 100 to communicate with other devices. Communication connection(s) 112 may include, but is not limited to, a modem, a Network Interface Card (NIC), or other interfaces for connecting computing device 100 to other computing devices. Communication connection(s) 112 may include a wired connection or a wireless connection. Communication connection(s) 112 may transmit and/or receive communication media.

Communication media typically embodies computer readable instructions or other data in a “modulated data signal” such as a carrier wave or other transport mechanism and includes any information delivery media. The term “computer readable media” may include communication media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

Device 100 may include input device(s) 114 such as keyboard, mouse, pen, voice input device, touch input device, infra-red cameras, video input devices, and/or any other input device. Output device(s) 116 such as one or more displays, speakers, printers, and/or any other output device may also be included in device 100. Input device(s) 114 and output device(s) 116 may be connected to device 100 via a wired connection, wireless connection, or any combination thereof. In one embodiment, an input device or an output device from another computing device may be used as input device(s) 114 or output device(s) 116 for computing device 100.

Components of computing device 100 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 100 may be interconnected by a network. For example, memory 104 may be comprised of multiple physical memory units located in different physical locations interconnected by a network.

Those skilled in the art will realize that storage devices utilized to store computer readable instructions may be distributed across a network. For example, a computing device 130 accessible via network 120 may store computer readable instructions to implement one or more embodiments of the invention. Computing device 100 may access computing device 130 and download a part or all of the computer readable instructions for execution. Alternatively, computing device 100 may download pieces of the computer readable instructions, as needed, or some instructions may be executed at computing device 100 and some at computing device 130. Those skilled in the art will also realize that all or a portion of the computer readable instructions may be carried out by a dedicated circuit, such as a Digital Signal Processor (DSP), programmable logic array, and the like.

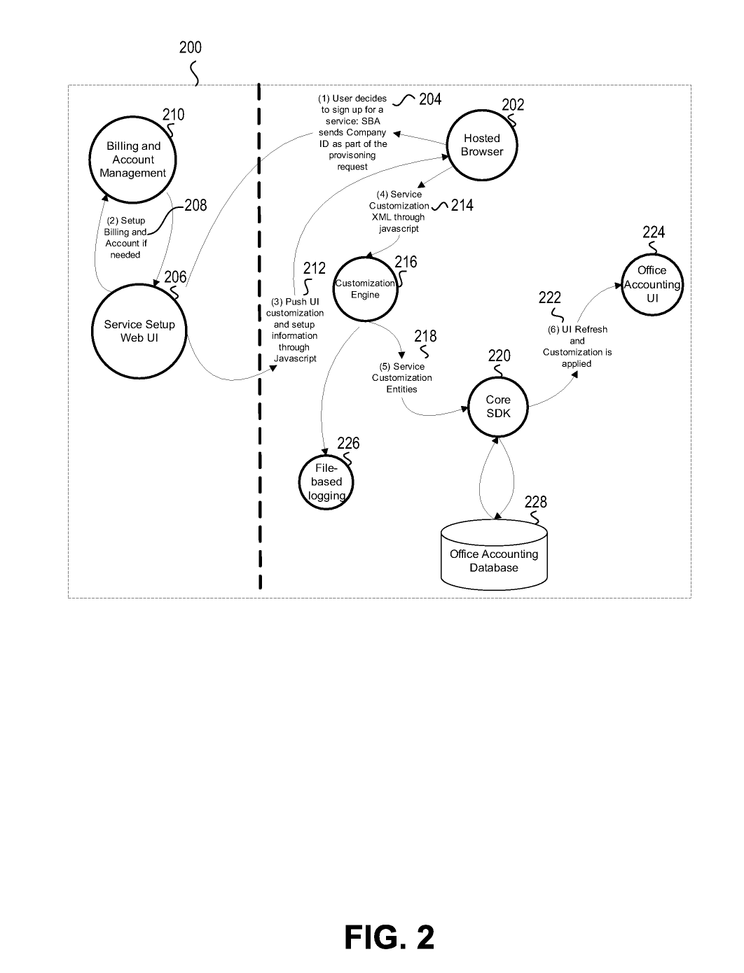

FIG. 2 shows a data flow diagram 200 illustrating how an example service is enlightened. At step 204, a user signs up for a service by opening the service setup web page in the web browser 202 hosted by the service. The service hosted browser 202 supports custom programming interfaces, for example JavaScript programming interfaces, in addition to standard web browser features. The service setup web user interface 206 collects setup billing and account information 208 using billing and account management 210. Upon collecting necessary billing and account information, the service page pushes user interface (UI) customization extensible markup language (XML) 212 to the service hosted browser 202 through a custom method call, for example, in Javascript.

The service hosted browser 202 interprets the custom method call and passes the UI customization XML 214 to a customization engine 216. The customization engine 216 then saves the customization information to a service database 228 using a core software development kit 220. The customization engine 216 then issues a request to the service to refresh the service user interface 224.

Note that after the user interface has been refreshed, the user interface customization pushed by the service becomes visible. In addition, the user interface customization is preserved across system restart and product upgrade because the customization information is stored in the database 228.

In an alternative embodiment, the service may be enlightened by including a user interface customization markup file, written in the extensible markup language (XML) for example, with a software installer. For example, during the installation or creation of a database, the on-premise software, for example Microsoft Office Accounting (MOA), loads the user interface customization markup language file and applies the customization to the user interface. User interface customization is applied and user interface elements pushed to users are displayed to users when the users interact with the on-premise software.

Note that the customization engine 216 may perform file-based logging 226.

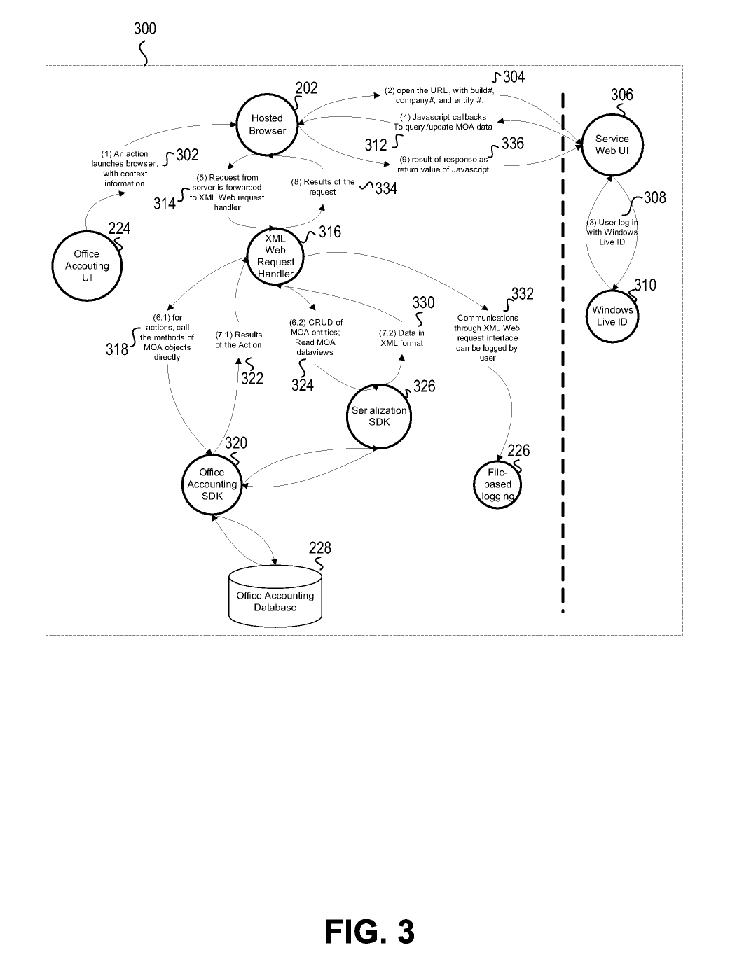

FIG. 3 shows a data flow diagram 300 illustrating data exchange between an example World Wide Web based service (web service) and one or more software development kits and/or on-premise software products. MOA, for example, attaches custom JavaScript handler to the hosted browser. To begin data flow, a user invokes a service action 302, for example as schedule shipping, by clicking a menu or button added by the service user interface 224 (from FIG. 2). The service then launches the hosted browser 202 (from FIG. 2) and associates 304 the uniform resource locator (URL) specified by the service action with the hosted browser 202.

A user of the service user interface 306 may log in to a validation service 310, for example Microsoft Windows Live, to verify the user's identity 308. The web service user interface passes data exchange markup language requests, for example in XML, to the hosted browser through custom code calls, for example, JavaScript calls.

At 312, custom code callbacks to query and/or update service data are returned to the hosted browser 202 from the web service user interface 306. Upon receiving the data exchange custom code, for example JavaScript, the hosted browser 202 forwards the request 314 to the XML web request handler 316. If it is determined that the request is just accessing service data, for example creating, reading, updating, or deleting (CRUD) data records and/or reading a data view and/or data table, the XML web request handler 316 translates the request 324 to a serialization software development kit 326 that is a markup language mapping of service data objects. The data in markup language format is then returned 330 to the XML web request handler 316.

If it is determined that the request is a business logic action, for example a pay an invoice with a check operation, the XML web request handler 316 directly converts the markup language action 318 to a function call to the service SDK 320, for example the MOA SDK. The results of the markup language action are returned 322 to the XML Web Request Handler 316.

The XML Web Request Handler 316 then converts the response to a standard markup language format, for example in XML, and sends the response 336 in the standard markup language back to the server 334 as the return result of the custom code call, for example, a JavaScript call. Note also that the XML Web Request Handler 316 may allow communications through the markup language web request interface to be logged by the user 332 using file based logging 226 (from FIG. 2).

An object access protocol such as the Simple Object Access Protocol (SOAP) may additionally or alternatively be used by a web service to perform data exchange with a service, for example MOA, for non-user interface asynchronous operations or the like. In particular, a generic object access client, for example SOAP, may be used by web services to integrate with the service, for example MOA.

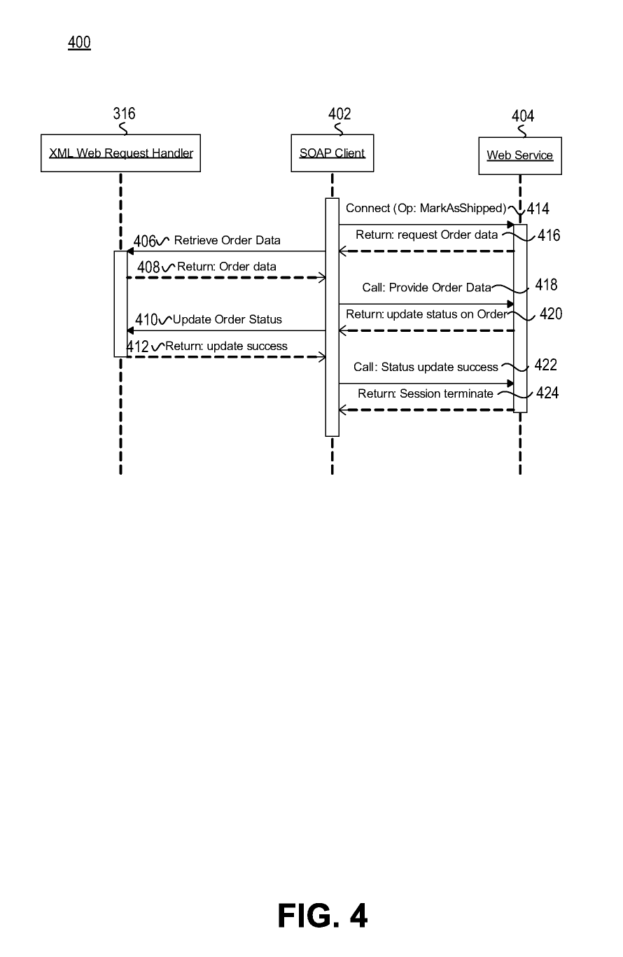

FIG. 4 shows an example operation for an example service to mark an example order as shipped 400. When the action is invoked, the SOAP client 402 sends a Connect request with an operation (Op) code defined by the service 414. In this example, the Op code is “MarkAsShipped”. The web service 404 returns with a XML data request 416. The SOAP client 402 forwards the request 406 to the XML web request handler 316 (from FIG. 3). The XML Web Request Handler 316 then returns the order data 408 to the SOAP client 402. In the next call to the web service 404, the SOAP client 402 forwards 418 the response to the previous request made by the web service 404.

If necessary, the web service 404 may return the call with another data request 420 to the SOAP client 402. The SOAP client then forwards the update order status operation 410 to the XML web request handler 316. The XML web request handler 316 then returns the update success message 412 to the SOAP client 402. The SOAP client 402 then forwards 422 the results of the previous request. The web service 404 may then return a session terminate 424 to end the session.

As can be seen, the web service 404 drives data exchange with the SOAP client 404. In particular, both the initial connect Op code 414 and the data requests 416, 420, are generated by the web service 404. More particularly, the SOAP client 402 exhibits generic and flexible behavior to handle data exchange of one or more types of web services.

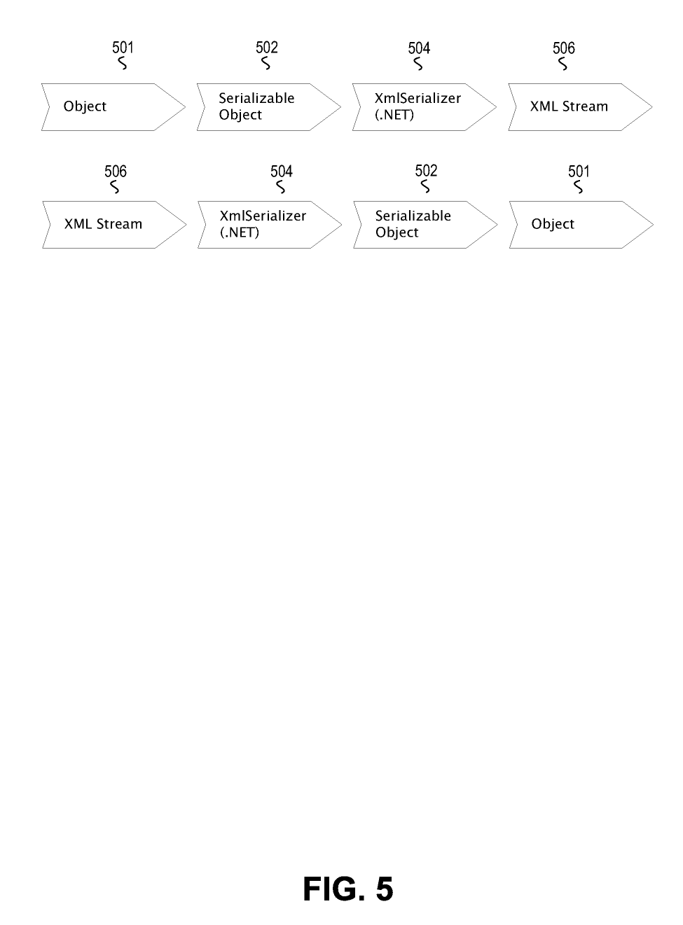

FIG. 5 illustrates an example serialization software development kit (SDK) 500. The serialization SDK 500 takes an existing data object 501 or data view in a on-premise software SDK, for example the MOA SDK, and produce a markup language document representation 506, for example an XML document representation, by first creating a serializable object 502 from the data object 502 and serializing it with a serializer 504, for example an XMLSerializer included as part of the Microsoft .Net Framework.

The example serialization SDK 500 may also reverse the process. For example, the markup language document representation 506 maybe be converted back to a data object 501 by passing the markup language document representation 506 to the serializer 504. In particular, metadata of software objects, for example MOA objects, may be compiled using a predefined set of templates to generate a proxy class for each class in a software SDK, for example the MOA SDK. The proxy class supports Microsoft .Net Framework serialization and converts a software object, for example an MOA object, to a serializable object. In this manner, service data objects, for example MOA data objects, may be serialized to XML and vice versa.

1. A framework system operable to customize a software product associated with a web service, the system comprising:
a customization engine;
a core software development kit coupled to the customization engine and operable to provide at least some of the functionality of the software product;
a user interface associated with the software product and with the core software development kit and with the web service;
a database coupled to the core software development kit; and
a service hosted browser coupled to the core software development kit and to the web service, wherein the service hosted browser supports a custom programming interface,
wherein a customization of the user interface is pushed to the service hosted browser via the custom programming interface, and then wherein the customization of the user interface is saved by the service hosted browser via the core software development kit in the database.

2. The system of claim 1 wherein the customization of the user interface is pushed to the service hosted browser in an extensible markup language (XML) format.

3. The system of claim 1 wherein the customization of the user interface is preserved across a software product upgrade.

4. The system of claim 1 wherein the customization of the user interface is preserved across a restart of the software product.

5. The system of claim 1 wherein use of the software product includes signing up for the web service.

6. The system of claim 1 wherein the software product is an on-premise software product associated with the web service.

7. The system of claim 1 wherein the software product is an accounting software product.

8. The system of claim 1 wherein the customization of the user interface becomes a part of the user interface upon a refresh request to the web service by the customization engine.

9. The system of claim 1 wherein the custom programming interface is based on JavaScript.

10. The system of claim 1 wherein the customization of the user interface is applied by a software installer.

11. A method of integrating a web service and a software product, the method comprising:
launching a browser based on an action of the software product, wherein the browser supports a custom programming interface, and wherein the browser accesses the web service responsive to the action;
receiving a forwarded request from the browser, the forwarded request sent from the web service in response to the action and received by the browser via the custom programming interface;
if the forwarded request is accessing service data related to the web service and software product, then:
accessing the service data in a database associated with the web service and the software product,
translating the service data via a serialization software development kit into a markup language format, and
returning the service data in the markup language format via the browser to the web service; and
if the forwarded request comprises an action related to the web service and software product, then:
converting the forwarded request to a function call,
making the function call to a service software development kit operable to provide at least some of the functionality of the software product,
receiving a result from the service software development kit responsive to the function call, and
returning the result in the markup language format via the browser to the web service,
wherein the translating and the converting and the markup language format provide at least a portion of the integrating.

12. The method of claim 11 wherein the markup language format comprises extensible markup language (XML).

13. The method of claim 11 wherein the custom programming interface is based on JavaScript.

14. The method of claim 11 wherein the custom programming interface is based on simple object access protocol (SOAP).

15. The method of claim 11 wherein the software product is an on-premise software product associated with the web service.

16. The method of claim 11 wherein the software product is an accounting software product.

17. The method of claim 11 wherein the forwarded request is processed by an extensible markup language (XML) web request handler to determine if the forwarded request is accessing service data or If the forwarded request comprises an action.

18. The method of claim 11 wherein the action comprises a uniform resource locator (URL) associated with the web service.

19. A method of customizing a software product associated with a web service, the method comprising:
receiving a customization of a user interface of the software product wherein the customization of the user interface is pushed by the web service to a service hosted browser via a custom programming interface of the service hosted browser; and
saving the customization of a user interface in a database associated with the software product wherein the customization of the user interface becomes a part of the user interface responsive to a refresh by the web service.

20. The method of claim 19 wherein the customization of the user interface is preserved across a software product upgrade and across a restart of the software product.
